(19) United States
(12) Patent Application Publication
(10) Pub. No.: US 2026/0155123 A1
(43) Pub. Date: Jun. 4, 2026

(54) ARTIFICIAL INTELLIGENCE (AI)-BASED CREATION SYSTEM AND METHOD FOR SMART GUITAR

(71) Applicants: Guangzhou Huancheng Cultural Media Co., Ltd., Guangzhou (CN); Dongguan Midiplus Electronic Technology Co., Ltd., Dongguan (CN)

(72) Inventors: Shuo JIA, Guangzhou (CN); Haojun ZHENG, Guangzhou (CN); Yiqiao WANG, Guangzhou (CN); Yitao HE, Guangzhou (CN); Bojia QU, Guangzhou (CN); Changjian WANG, Guangzhou (CN); Mingqiang HAO, Dongguan (CN); Jin YANG, Dongguan (CN); Zhuohuang LIN, Dongguan (CN)

(21) Appl. No.: 19/454,552

(22) Filed: Jan. 21, 2026

(30) Foreign Application Priority Data
Sep. 18, 2025 (CN) 202511334239.7
Nov. 18, 2025 (CN) 202511686228.5

(51) Int. Cl. G10H 1/00; G06N 3/08

(52) U.S. Cl. CPC G10H 1/0008; G06N 3/08; G10H 2220/026; G10H 2230/135

(57) ABSTRACT

An artificial intelligence (AI)-based creation system for a smart guitar, including a function selection module, a connection management module, an input acquisition module, an AI-based generation module and an execution feedback module. Simple user inputs are acquired through the input acquisition module on a smart guitar. A structurally complete professional music score file and accompaniment audio file are automatically generated by a cloud-based AI-based generation module. The generated music score file and accompaniment audio file are transmitted back to the smart guitar in real time via an established communication link. The music score file is parsed by the execution feedback module on the smart guitar, lights on the fretboard are precisely driven to indicate fretting positions and performance timing, and the accompaniment audio file is synchronously played.

### CROSS-REFERENCE TO RELATED APPLICATIONS

This application claims the benefit of priority from Chinese Patent Application No. 202511686228.5, filed on Nov. 18, 2025 and Chinese Patent Application No. 202511334239.7, filed on Sep. 18, 2025. The content of the aforementioned application, including any intervening amendments made thereto, is incorporated herein by reference in its entirety.

### TECHNICAL FIELD

This application relates to smart guitars, and more particularly to an artificial intelligence (AI)-based creation system and method for a smart guitar.

### BACKGROUND

Smart guitars have been extensively popularized among music enthusiasts and guitar learners. Through the integration of a sensor and a processor, smart guitars possess the functions of music score display and rhythm control, making it more convenient for users to learn and play. However, in practical use, the existing smart guitars generally require users to possess a proficient understanding of music theory in order to create a complete musical piece, making it difficult for non-professional musicians to independently complete musical creation, and resulting in a relatively high creation threshold. In addition, most of the existing artificial intelligence (AI)-based composing tools can only generate audio content, and fail to interact with instrument hardware to achieve the real-time performance.

### SUMMARY

In view of the defects in the prior art, an object of the present disclosure is to provide an artificial intelligence (AI)-based creation system and method for a smart guitar, so as to enhance the interaction between a user and the smart guitar, and reduce the requirement for users' music theory knowledge.

Technical solutions of the present disclosure are described as follows.

To achieve the above objectives, in a first aspect, this application provides an AI-based creation system for a smart guitar, comprising:
a function selection module;
a connection management module;
an input acquisition module;
an AI-based generation module; and
an execution feedback module;
wherein the function selection module is integrated into a display screen of the smart guitar, an application program of a mobile device or a combination thereof, and is configured to trigger an AI-based creation function;
the input acquisition module is configured to acquire user input information;
the connection management module is integrated into the smart guitar, and is configured to establish a communication link and transmit the user input information to the AI-based generation module;
the AI-based generation module is deployed on a cloud-based AI server, and is configured to receive chord data and the user input information, and output a structured music score file and an audio file; and
the execution feedback module is integrated into the smart guitar, and is configured to parse the structured music score file to trigger a light indication and play the audio file in accordance with user's performance.

In some embodiments, the AI-based generation module comprises at least one AI creation model; and the at least one AI creation model is constructed by training a deep learning neural network using note information, lyric information and audio information.

In some embodiments, the input acquisition module comprises a chord touch button, a light-emitting diode (LED) light strip, a monophonic component, a toggling lever, an AI creation parameter input interface and an acquisition component;
the chord touch button is arranged at a neck portion of the smart guitar; a pressure sensor is provided below the chord touch button, and is configured to detect chord press;
the LED light strip is arranged at the neck portion of the smart guitar, and is configured to provide the light indication;
the monophonic component is arranged at a body of the smart guitar, and is configured to be triggered synchronously with the chord touch button;
the toggling lever is configured to detect upward or downward toggling actions and a push speed;
the AI creation parameter input interface is configured to receive an AI creation parameter input by a user; and
the acquisition component is configured to acquire the user input information via the application program of the mobile device.

In some embodiments, the user input information comprises audio, video, link, note, chord information, text, voice, image or a combination thereof.

In some embodiments, the monophonic component comprises a silicone base block and a plurality of string-plucking pieces;
wherein the plurality of string-plucking pieces are independent from each another, and are configured to protrude from a surface of the silicone base block;
each of the plurality of string-plucking pieces has a light-transmitting region and an LED light source corresponding to a bottom thereof; and
the pressure sensor is connected below each of the plurality of string-plucking pieces.

In some embodiments, the plurality of string-plucking pieces each have an elongated shape, and are uniformly arranged;
each of the plurality of string-plucking pieces has a length covering projection areas of six strings of the smart guitar;
the light-transmitting region is arranged at a top of each of the plurality of string-plucking pieces, and is configured as a circular opening or a semi-transparent silicone window; and
a center of the light-transmitting region is aligned with a projection of a corresponding string.

In some embodiments, the structured music score file comprises a chord sequence, a timestamp, a beats per minute (BPM) value and a timing error threshold;
the chord sequence is a chord identifier array corresponding fret codes of the chord touch button arranged at the neck portion of the smart guitar;
the timestamp indicates an absolute time point for each chord transition;
the BPM value represents beats per minute; and
the timing error threshold represents an allowable playing error for user performance, and is calculated based on the BPM value.

In some embodiments, the execution feedback module comprises a music score parsing unit, a light driving unit, an audio synchronization unit and a comparison unit;
the music score parsing unit is configured to extract a timestamp and a chord sequence from the structured music score file;
the light driving unit is configured to control a light-up sequence of LEDs according to the timestamp;
the audio synchronization unit is configured to synchronize a playback progress with the light-up sequence of the LEDs; and
the comparison unit is configured to monitor a match degree between a chord played by a user and the chord sequence, and provide feedback to the user in case of a mismatch.

In a second aspect, this application provides an AI-based creation method, the AI-based creation method being implemented by the AI-based creation system described above, and the AI-based creation method comprising:
(S1) selecting and triggering, by a user via the display screen of the smart guitar or a bound mobile application, the AI-based creation function;
(S2) guiding, by the AI-based creation system, the user to input an AI creation parameter via a guitar input interface, the bound mobile application or a combination thereof;
(S3) collecting physical operation inputs from the user to the smart guitar, wherein the physical operation inputs comprise triggering a chord touch button, a monophonic button, a toggling action, a transposition operation or a tempo change operation;
(S4) transmitting, in real time, the AI creation parameter collected in step S2 and the physical operation inputs collected in step S3 to the cloud-based AI server;
(S5) generating, by the cloud-based AI server, the structured music score file and the audio file based on received data;
(S6) pushing, by the cloud-based AI server, the structured music score file and the audio file to the smart guitar, the bound mobile application or a combination thereof; and
(S7) receiving and parsing, by the smart guitar, the structured music score file to drive a LED light strip according to a timestamp to guide performance, and synchronously play the audio file.

In some embodiments, the AI-based creation method, before the step S1, further comprising:
(S11) displaying, on the display screen of the smart guitar, a quick response (QR) code or a link guide for downloading the bound mobile application;
(S12) after launching the bound mobile application, collecting a device ID of the smart guitar, and uploading the device ID together with a user account to the cloud-based AI server; and
(S13) verifying, by the cloud-based AI server, validity of the device ID, and, upon successful verification, establishing and recording a binding relationship among the smart guitar, the bound mobile application and the user account.

In some embodiments, the step S4 comprises:
(S41) packaging real-time data from hardware of the smart guitar, wherein the real-time data comprises a transposition parameter obtained by monitoring a transposition touch button, a tempo parameter obtained by parsing the toggling action, and chord button pressure data obtained from a pressure sensor;
(S42) packaging creation parameters from the bound mobile application, wherein the creation parameters comprise input text of the user, recognized voice commands, analyzed image features, extracted audio melody and rhythm, parsed video content, information obtained from links, and directly inputted notes, chord data or a combination thereof; and
(S43) tagging all packaged data with a unified timestamp, and transmitting tagged data to the cloud-based AI server in real time and synchronously.

In some embodiments, in step S7, the step of driving the LED light strip according to the timestamp to guide performance, and synchronously playing the audio comprises:
(S71) illuminating LEDs within a target chord area 500 ms before a target timestamp;
(S72) in the case of a performance error, repeating playback of a previous audio segment until a first chord timestamp is reached; and
(S73) matching a playback progress with timestamps in the structured music score file in real time.

Compared to the prior art, the present disclosure has the following beneficial effects.

The smart guitar AI-based creation system, including a function selection module, a connection management module, an input acquisition module, an AI-based generation module and an execution feedback module. The function selection module is integrated into a display screen of the smart guitar, an application program of a mobile device or a combination thereof, and is configured to trigger an AI-based creation function. The input acquisition module is configured to acquire user input information. The connection management module is integrated into the smart guitar, and is configured to establish a communication link and transmit the user input information to the AI-based generation module. The AI-based generation module is deployed on a cloud-based AI server, and is configured to receive chord data and the user input information, and output a structured music score file and an audio file. The execution feedback module is integrated into the smart guitar, and is configured to parse the structured music score file to trigger a light indication and play the audio file in accordance with user's performance.

The present disclosure enables the automatic generation of fully structured professional music score and accompaniment audio based on simple user input acquired via the guitar-side input acquisition module, such as basic chords or textual descriptions. The generated music score and audio are transmitted in real time to the smart guitar via an established communication link. The guitar-side execution feedback module parses the music score, drives LEDs on the fretboard to precisely indicate chord positions and performance rhythm, and simultaneously plays the accompaniment audio. This significantly reduces the threshold for music creation and performance, allowing non-professional users to easily produce complete musical works without extensive music theory knowledge. Moreover, the system achieves real-time, deep integration between AI large model for music generation and the physical instrument, enabling users to perform the newly generated music score and audio in sync with the LED guidance, thereby providing an immersive “what you imagine is what you get, and what you get can be played” creative and performance experience that is convenient to use.

### BRIEF DESCRIPTION OF THE DRAWINGS

FIG. 1 is a structural diagram of an artificial intelligence (AI)-based creation system for a smart guitar; and

FIG. 2 is a flowchart of the AI-based creation system.

### DETAILED DESCRIPTION OF EMBODIMENTS

The present disclosure will be further described in conjunction with the accompanying drawings. It should be understood that the embodiments described herein are provided solely for the purpose of illustrating the disclosure and are not intended to limit the scope of the disclosure. It should also be noted that, for the sake of clarity, the accompanying drawings only depict the portions relevant to the present disclosure, rather than all structures.

Prior to a more detailed discussion of the embodiments, it should be noted that some embodiments are described as processes or methods represented in flowcharts. Although the flowcharts depict the steps as sequential operations, a number of the steps may be performed in parallel, concurrently or simultaneously. Moreover, the order of the steps may be rearranged. Upon completion of their execution, the processes may terminate, but additional steps not shown in the accompanying drawings may also be included. The processes may correspond to methods, functions, routines, subroutines or procedures.

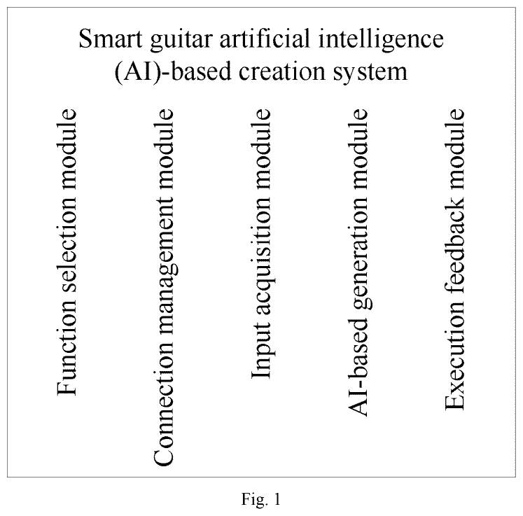

As shown in FIG. 1, an embodiment of the present disclosure provides an artificial intelligence (AI)-based creation system for a smart guitar, including a function selection module, a connection management module, an input acquisition module, an AI-based generation module and an execution feedback module.

The function selection module is integrated into a display screen of the smart guitar, an application program of a mobile device or a combination thereof, and is configured to trigger an AI-based creation function. A user may activate the AI-based creation function via a touch screen integrated in the guitar body (such as an Organic Light-Emitting Diode (OLED) or Liquid Crystal Display (LCD)) or through the application program of the mobile device. The function selection module may include a built-in quick response (QR) code generation chip.

The input acquisition module is configured to acquire user input information.

The connection management module is integrated into the smart guitar, and is configured to establish a communication link for transmitting the user input information to the AI-based generation module. The connection management module may be configured as a Bluetooth, Bluetooth Low Energy (BLE), or Wi-Fi module integrated within the smart guitar, and is configured to establish a binding connection with a cloud-based AI server.

The AI-based generation module is deployed on the cloud-based AI server, and is configured to receive chord data and the user input information, and output a structured music score file and an audio file. The cloud-based AI server may be configured with a graphics processing unit (GPU) cluster to support the AI-based generation model (such as a Transformer), and the audio file may be in MP3 or WAV format.

The AI-based generation module of the present disclosure includes at least one AI creation model. The at least one AI creation model is constructed by training a deep learning neural network using note information, lyric information and audio information. Specifically, the at least one AI-based generation module is configured to receive a chord progression sequence and style text parameters from a guitar-side device, and to perform computation using a built-in deep learning-based neural network model, so as to generate the structured music score file (such as Musical Instrument Digital Interface (MIDI) files) and an accompaniment audio file (such as MP3 files) that conform to a user's intent and have a complete musical structure, and to return the generated files to a guitar device side. The at least one AI creation model may be trained based on a large-scale, multi-source, heterogeneous music corpus. Using the constructed music corpus, the deep learning neural network is trained in a supervised learning and autoregressive manner, with a training objective of enabling the AI creation model to maximize the generation of melodies, rhythms, and accompaniment textures that are statistically and musically similar to real music data in the training dataset, under conditions of given arbitrary chord sequences and style labels. When the trained AI creation model is applied in practical use, an operational workflow thereof may be as follows. The cloud-based AI server receives, via a communication link, a request from a smart guitar application, where the request includes a basic chord sequence input by the user and selected style parameters. The chord sequence and the style text are input into the trained deep learning neural network. Within the deep learning neural network model, forward computation is performed, where a user intent is interpreted by an encoder and a complete, multi-track musical structure is generated by a decoder on a per-note and per-beat basis. Symbolic music data output by the trained AI creation model, including notes, velocities and durations, are automatically arranged and written into a structured music score file (such as a standard MIDI file). In addition, by means of virtual studio technology instruments (VSTi) or a neural audio synthesizer, the MIDI file is rendered into a high-fidelity accompaniment audio file with rich instrumental timbres. The generated structured music score file and the accompaniment audio file, which may further include lyrics or vocal performances, are returned together to a user's mobile application and the smart guitar, thereby completing an AI creation request.

In some embodiments, the AI-based generation module serves as a general-purpose music intelligent processing core, which may be adapted to various types of smart musical instruments. The AI-based generation module receives structured data that has been preprocessed and standardized by a front-end device. For a guitar, such data include a chord sequence and tempo information. For other instruments, the data may include corresponding standardized musical instructions. For example, when applied to a smart ukulele, which is structurally highly similar to a guitar but differs in the number of strings and tuning, the system only needs to configure a different pitch mapping table and chord library for the ukulele client, thereby seamlessly interfacing with the same cloud-based AI-based generation module.

The execution feedback module is integrated into the smart guitar, and is configured to parse the structured music score file to trigger a light indication and play the audio file in accordance with user's performance. The smart guitar is equipped with a built-in microcontroller unit (MCU), such as an STM32F4 (STMicroelectronics), which drives an audio decoding chip, and employs the Message Queuing Telemetry Transport (MQTT) protocol for data transmission (guitar to cloud). The cloud-based AI server synthesizes MIDI audio using SoundFont technology or generates MP3 files. Simple user input, such as basic chords or textual descriptions, is collected via the input acquisition module of the smart guitar. A structurally complete professional music score file and accompanying audio are automatically created using the cloud-based AI-based generation module. The generated music score is transmitted back to the smart guitar in real time via the established communication link. The execution feedback module of the smart guitar parses the music score, drives the LEDs on the fretboard to precisely indicate chord positions and performance rhythm, and simultaneously plays the accompaniment audio. This significantly lowers the threshold for music creation and performance, allowing non-professional users to easily generate complete musical works without extensive music theory knowledge. Moreover, the system achieves deep, real-time interaction between the AI large model for music generation and the physical instrument, enabling users to perform the newly generated sheet music and audio in sync with the LED guidance, thereby providing an immersive “what you imagine is what you play, and what you get can be played” creative performance experience that is convenient to use.

The input acquisition module includes a chord touch button, a light-emitting diode (LED) light strip, a monophonic component, a toggling lever assembly, an AI creation parameter input interface and an acquisition component.

The chord touch button is arranged at a neck portion of the smart guitar. A pressure sensor is provided below the chord touch button, and is configured to detect chord press. Specifically, each fret of the neck portion of the smart guitar is provided with a film-type pressure sensor configured to output an analog signal, which is converted by an analog-to-digital converter (ADC).

The LED light strip is arranged at the neck portion of the smart guitar, and is configured to provide the light indication. Specifically, each fret corresponds to an RGB LED controlled by a built-in MCU within the guitar body.

The monophonic component is arranged at a body of the smart guitar, and is configured to be triggered synchronously with the chord touch button.

The toggling lever assembly is configured to detect upward or downward toggling actions and a push speed. Specifically, the toggling lever may include a first toggling lever and a second toggling lever, and a corresponding function is triggered only when a toggling action of either toggling lever is detected in combination with a chord fret button. When the chord fret button is triggered alone, a string-strumming effect sound is produced. An output rhythm intensity is dynamically adjusted based on the push speed of the toggling lever assembly, with the speed positively correlated with the intensity. Under a default configuration, actuating the first toggling lever triggers arpeggiated chords, while actuating the second toggling lever triggers strummed chords. Specifically, a single activation of the toggling lever assembly triggers the random playback of an audio clip in MP3 or WAV format (with a duration of 2-4 s) from a playlist. The mobile application sends a 0xFF stop code to terminate current playback before starting a new track. Style parameters are stored in a ferroelectric random-access memory (FRAM) non-volatile memory, allowing users to perform improvisational music creation via AI, stimulating musical ideas through fragmented audio, and enabling checkpoint memory. Style configurations are permanently stored in memory without the need for repeated configuration.

The AI creation parameter input interface is configured to receive text parameters and may invoke a mobile device speech recognition application programming interface (API) (e.g., Google Automatic Speech Recognition (ASR)) or a text input field for recognition. By combining multimodal inputs (physical presses combined with APP parameters), user intent is accurately captured. The neck LEDs provide real-time guidance for press positions, and the string-plucking pieces ensure rhythm synchronization while preventing false triggering. The hardware design is compatible with standard guitar structures without altering playing habits.

The acquisition component is configured to acquire the user input information through the application program of the mobile device. The user input information includes audio, video, link, note, chord information, text, voice, image or a combination thereof. Specifically, the disclosure may provide a dedicated mobile application (APP). The dedicated mobile APP is configured to exchange data with the connection management module on the smart guitar via a wireless communication protocol, such as Bluetooth or Wi-Fi. The dedicated APP is configured to access the microphone of the mobile device to record user-hummed melodies, whistling, or rhythms, and convert the analog audio signals into digital note sequences or rhythm data via built-in audio processing algorithms, such as fundamental frequency extraction and beat detection.

The dedicated APP is further configured to access the camera of the mobile device to capture user performance gestures, dance movements, or any visually rhythmic content, and to analyze the video frames using computer vision algorithms to extract motion rhythms and patterns, which serve as visual rhythm references for AI-generated music. The APP provides an input field allowing users to paste a network link, and the system backend service is configured to crawl and parse content from the provided link. For example:
Lyrics link: Text is extracted from a lyric website, and its semantics and emotion are analyzed.
Music or video links: A source file is crawled and downloaded from a music or video platform, from which an audio track is extracted for analysis, and metadata (such as genre and beats per minute (BPM)) is read.
Image links: An image is downloaded and subjected to image recognition, where visual themes (e.g., “forest” or “city”) and color emotions are translated into inspiration parameters for music creation.
Text input: The application program of the mobile device provides a text input field, allowing users to input more complex creative prompts, such as a story segment, a description of a scene or mood, or more detailed musical style requirements.
Voice input: Users directly speak creative requirements, and the application utilizes speech recognition technology to convert the speech into text instructions.

All user input information collected from the guitar hardware and the mobile application is ultimately uniformly encapsulated and packaged by the connection management module, and then transmitted via an established communication link (e.g., Wi-Fi or 5G) to the AI-based generation module deployed in the cloud. The mobile application can serve both as an independent input source and as a supplement and relay for input information from the guitar, thereby forming a multimodal, three-dimensional creative input ecosystem.

The monophonic component includes a silicone base block and a plurality of string-plucking pieces. The plurality of string-plucking pieces are independent from each another, and are configured to protrude from a surface of the silicone base block. Each of the plurality of string-plucking pieces has a light-transmitting region and an LED light source corresponding to a bottom thereof. The pressure sensor is connected below each of the plurality of string-plucking pieces.

In this embodiment, the pressure sensor is configured as a piezoresistive thin-film sensor with a relatively small thickness, thereby preserving the authentic plucking feel of the string-plucking pieces. Concurrently, the piezoresistive thin-film sensor is capable of monitoring force distribution in real time. By combining the contact centroid of a user's finger during picking, the system can distinguish between an upward picking action and a downward strumming action. When pressed, the internal conductive network of the sensor undergoes a change in contact area, thereby converting the pressing force into an electrical signal represented by a change in resistance. A processor can add performance technique sound effects (such as strumming noise, nail-on-string sound, etc.) based on different actions, and can simultaneously cooperate with the chord touch button for bimanual coordination detection, thereby preventing erroneous playing habits.

The string-plucking pieces each have an elongated shape, and are uniformly arranged. Each string-plucking piece has a length covering projection areas of six strings of the smart guitar. The light-transmitting region is arranged at a top of each of the plurality of string-plucking pieces, and is configured as a circular opening or a semi-transparent silicone window. A center of the light-transmitting region is aligned with a projection of a corresponding string. Each string-plucking piece corresponds to the projection area of a string, conforming to the playing habits of a traditional guitar and effectively helping beginners develop correct playing techniques.

The present disclosure further enables monophonic playing and singing via MIDI data, specifically as follows: A static mapping table is established to store a correspondence between chord key IDs and monophonic key IDs, where each monophonic key ID is associated with a set of MIDI note sequences. A root note MIDI value for each chord is stored, supporting dynamic adjustment of a root note offset. When activation of a chord key is detected, a current chord ID is locked. When triggering of a monophonic key is detected, the mapping table is queried to obtain a corresponding MIDI note sequence. MIDI information is then generated and subjected to interference-resistant processing. The processed MIDI signals are output to an external sound source device. By establishing the static mapping table to map monophonic keys to chord keys, complex chord fingerings are simplified into single-key triggering, thereby lowering the performance threshold. Storing root note values and supporting dynamic pitch shifting allows the user to dynamically adjust the root note according to need, avoiding reconstruction of the traditional mapping table and ensuring smooth playing rhythm. Meanwhile, interference-resistant processing is performed on the MIDI signals to output highly reliable MIDI signals, thereby effectively improving performance accuracy.

The structured music score file includes a chord sequence, a timestamp, a beats per minute (BPM) value and a timing error threshold. The chord sequence is a chord identifier array corresponding to fret codes of the chord touch button arranged at the neck portion of the smart guitar. The timestamp indicates an absolute time point for each chord transition. The BPM value represents beats per minute. The timing error threshold represents an allowable playing error for user performance, and is calculated based on the BPM value.

The structured music score file of the present disclosure may store data in JavaScript Object Notation (JSON) format, including data such as a chord trigger sequence, slice start and end timestamps, tempo, key, and chord properties, thereby enabling cross-platform compatibility.

The structured music score file of the present disclosure further includes the BPM value. The timing error threshold is calculated based on the BPM value according to the following formula:

$$Timing Error Threshold = \frac{60000}{BPM \times N} .$$

In the above formula, N is the number of beats per measure, with a default value of 4. For example, when BPM=120, the timing error threshold is 60000/(120*4)=125 ms. The tolerance window is automatically adjusted according to the BPM: fast-tempo pieces have a wider tolerance window, while slow-tempo pieces are calibrated more strictly. This effectively balances performance flexibility and accuracy.

The execution feedback module of the present disclosure includes a music score parsing unit, a light driving unit, an audio synchronization unit and a comparison unit. The music score parsing unit is configured to extract a timestamp and a chord sequence from the structured music score file. The light driving unit is configured to control a light-up sequence of LEDs according to the timestamp. The audio synchronization unit is configured to synchronize a playback progress with the light-up sequence of the LEDs. The comparison unit is configured to monitor a match degree between a chord played by a user and the chord sequence, and provides feedback to the user in case of a mismatch.

Specifically, an LED light strip is embedded along the side edge or front surface of the guitar fretboard, with each LED corresponding to a fret. Prior to the arrival of a standard note, the LED corresponding to the fret lights up (e.g., in blue) as a preview. If the user presses and plays the note at the correct time, the LED turns green to indicate success. If the timing is missed or the wrong note is played, the LED turns red or flashes to indicate an error. When the note ends, the LED turns off. This allows the user to receive highly intuitive feedback on “where to press, when to press, and whether it is correct” without taking their eyes off the fretboard. Additionally, the system may provide a “falling grid” visual cue on the display screen integrated into the guitar body, creating an interface similar to a rhythm game. One side of the screen represents the “future” and standard notes (or chord icons) move horizontally across the screen like blocks in time with the rhythm toward a designated position. A vertical judgment line is located at the center of the screen, and when a “note block” aligns with the judgment line, it indicates the optimal timing for performance, and the user must perform accurately as the block reaches the line. The system displays judgment results such as “Perfect”, “Good” or “Miss” on the screen based on the results from the comparison unit, accompanied by score updates. Correct notes played by the user are actually sounded through the guitar amplifier. When the user makes an error, a correct sound effect is automatically inserted or a gentle prompt tone is provided to assist the user in auditory calibration. This transforms tedious practice into an exciting game, motivating the user to continuously challenge for higher accuracy through scores and combo counts, thereby enhancing the user experience while helping beginners quickly develop a sense of rhythm on the guitar.

The execution feedback module of the present disclosure can control LED colors via Pulse-Width Modulation (PWM) dimming, output audio to a power amplifier chip through an Inter-IC Sound Interface (I²S) interface, and schedule lighting and audio events based on a real-time operating system. A dynamic time warping algorithm may be employed to match the user's pressing sequence with a target chord. A real-time error correction mechanism functions as an “AI tutor” to help the user quickly correct performance errors, thereby significantly improving practice efficiency.

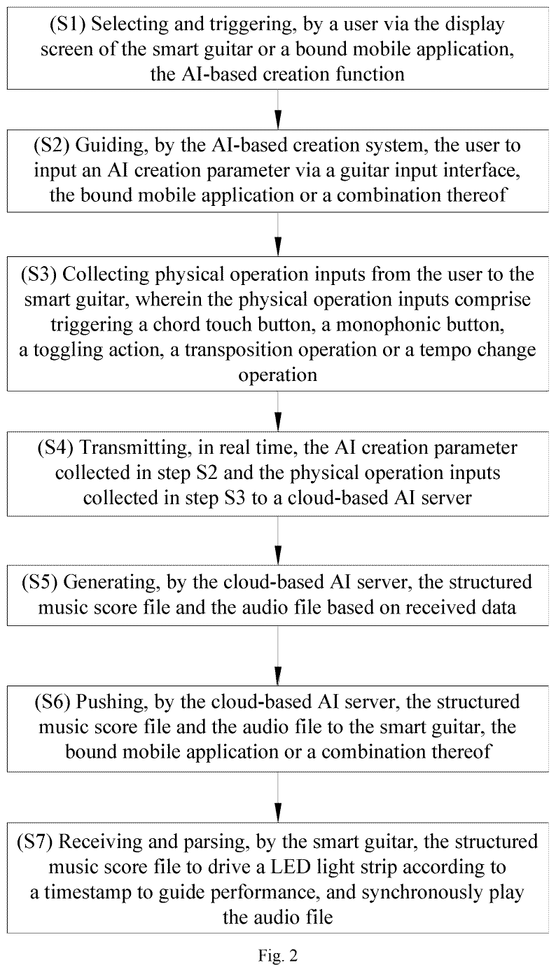

As shown in FIG. 2, the present disclosure also provides an AI-based creation method, the AI-based creation method is implemented by the AI-based creation system described above, and the AI-based creation method including the following steps.
S1. The AI-based creation function is selected and triggered by a user via the display screen of the smart guitar or a bound mobile application.
S2. The user is guided by the AI-based creation system to input an AI creation parameter via a guitar input interface, the bound mobile application or a combination thereof.
S3. Physical operation inputs from the user to the smart guitar are collected, where the physical operation inputs include triggering a chord touch button, a monophonic button, a toggling action, a transposition operation, or a tempo change operation.
S4. The AI creation parameter collected in step S2 and the physical operation inputs collected in step S3 are transmitted, in real time, to a cloud-based AI server.
S5. The structured music score file and the audio file are generated by the cloud-based AI server based on received data.
S6. The structured music score file and the audio file are pushed by the cloud-based AI server to the smart guitar, the bound mobile application or a combination thereof.
S7. The structured music score file is received and parsed by the smart guitar to drive a LED light strip according to a timestamp to guide performance, and synchronously play the audio file.

The user may directly browse the function menu on the touch screen of the smart guitar to select the AI-based creation function, or open the mobile application on a smartphone, select the bound smart guitar from the device list, and then choose the AI-based creation function. The connection management module performs data fusion and packaging of all information from the guitar hardware (including chord sequences, transposition parameters, tempo parameters, and pressure data) and from the mobile application (including text, speech recognition results, image feature vectors, and link analysis data). A unified timestamp is applied to all data streams, which are then transmitted in real time to the cloud-based AI server via a Wi-Fi network. Upon receiving the fused data, the cloud-based AI server activates the AI-based generation module to interpret the user's intent and perform musical creation, ultimately generating a structured music score file (e.g., in JSON format, including notes, chords, rhythm, and light instructions) and a complete audio file (e.g., in MP3 format), which are then delivered to the smart guitar. The present disclosure transforms the professional music creation process into an intuitive multimodal interaction, allowing users to obtain professional musical works without requiring proficiency in music theory or instrumental performance. Users can simply describe their ideas, upload materials, or perform basic guitar interactions to achieve musical creation, thereby realizing “music creation for everyone”. Furthermore, by introducing the mobile APP as an input source, creative inspiration is no longer limited to the guitar hardware; text, images, voice and video can all serve as sources of creation, quickly transforming any moment of inspiration in daily life into music. This greatly stimulates users' creative desire and personalizes their works. By deeply integrating smart hardware, mobile applications and cloud-based AI capabilities, the present disclosure fundamentally transforms the traditional paradigm of music creation, delivering a previously unavailable, convenient, and powerful music creation experience to users.

Before the step S1, the method further including the following steps.
S11. A quick response (QR) code or a link guide for downloading the bound mobile application is displayed on the display screen of the smart guitar. The smart guitar may present a dedicated QR code on the display screen, which encodes basic device information, a pairing password, and a direct link to an application store or the official website's application download page, thereby ensuring that the user obtains the official genuine application through a proper channel and avoiding risks associated with installing third-party applications.
S12. After launching the bound mobile application, a device ID of the smart guitar is collected, and the device ID together with a user account is uploaded to the cloud-based AI server. After the mobile application is installed and launched, nearby smart guitars in a connectable state are automatically scanned and detected via a Bluetooth Low Energy (BLE) protocol. A BLE connection is established by the application, and a secure request command is sent to the smart guitar. A unique device ID (typically a programmed globally unique identifier) is read by the main control MCU of the guitar from a secure storage area (e.g., a Secure Element (SE) chip) and returned to the application. The user completes registration or login within the application, at which time the device ID is logically associated with the user account and encryptedly uploaded to the cloud-based AI server via the HyperText Transfer Protocol Secure (HTTPS) protocol.
S13. Validity of the device ID is verified by the cloud-based AI server, and, upon successful verification, a binding relationship among the smart guitar the bound mobile application, and the user account is established and recorded. After receiving the binding request, the cloud-based AI server queries the device ID in its legitimate device database (whitelist), which is pre-loaded by the manufacturer during device production. The verification includes: checking for existence, i.e., whether the ID is present; checking for status, i.e., whether the device has already been activated and bound to prevent duplicate binding; and checking for legitimacy, i.e., whether the ID is a valid factory serial number for anti-counterfeiting.

After successful verification, a permanent record is created in the cloud-based AI server's user-device relationship database. Thereafter, all requests originating from that device or that user account are processed under this binding relationship. By employing a factory whitelist mechanism, unauthorized devices are effectively prevented from accessing the cloud services, thereby protecting the interests of legitimate manufacturers and ensuring the security of cloud resources.

The step S4 includes the following steps.
S41. Real-time data from hardware of the smart guitar are packaged, where the real-time data includes a transposition parameter obtained by monitoring a transposition touch button, a tempo parameter obtained by parsing the toggling action, and chord button pressure data obtained from a pressure sensor.
S42. Creation parameters from the bound mobile application are packaged, where the creation parameters include input text of the user, recognized voice commands, analyzed image features, extracted audio melody and rhythm, parsed video content, information obtained from links, and directly inputted notes, chord data or a combination thereof.
S43. All packaged data are tagged with a unified timestamp, and tagged data are transmitted to the cloud-based AI server in real time and synchronously.

In step S7, a LED light strip is driven according to a timestamp to guide performance, and the audio file is played synchronously, which specifically includes the following steps.
S71. LEDs within a target chord area is illuminated 500 ms before a target timestamp. When the structured music score file is parsed, the execution feedback module preloads instructions for a subsequent period (e.g., 2 s) in advance. When a system clock reaches T-500 ms (where T is an exact timestamp at which a target chord is to be played), an instruction is sent by a guitar main controller to the LED light strip. Using PWM technology, an LED corresponding to the target chord position is modulated from dark to bright, completing a smooth fade-in effect within 200-300 ms, and is finally maintained at a high brightness level until the timestamp T is reached. This conforms to human anticipation and reaction time characteristics, thereby providing sufficient preparation time for a user.
S72. In the case of a performance error, playback of a previous audio segment is repeated until a first chord timestamp is reached. This error-repeat mechanism isolates difficult practice passages, allowing the user to focus on correcting mistakes without interrupting the musical flow, thereby significantly improving learning efficiency and confidence.
S73. A playback progress is matched with timestamps in the structured music score file in real time. Audio playback is delayed until the first chord timestamp is reached, eliminating audio-visual desynchronization caused by wireless transmission jitter. The playback progress is aligned in real time with the sheet music timeline, ensuring that the accompaniment remains synchronized with the light guidance and guaranteeing smooth and error-free performance.

Described above are merely preferred embodiments of the present disclosure, and are not intended to limit the scope of the present disclosure. It should be understood that various modifications, changes and replacements made by those skilled in the art without departing from the spirit of the disclosure shall fall within the scope of the present disclosure defined by the appended claims.

What is claimed is:

1. An artificial intelligence (AI)-based creation system for a smart guitar, comprising:
a function selection module;
a connection management module;
an input acquisition module;
an AI-based generation module; and
an execution feedback module;
wherein the function selection module is integrated into a display screen of the smart guitar, an application program of a mobile device or a combination thereof, and is configured to trigger an AI-based creation function;
the input acquisition module is configured to acquire user input information;
the connection management module is integrated into the smart guitar, and is configured to establish a communication link and transmit the user input information to the AI-based generation module;
the AI-based generation module is deployed on a cloud-based AI server, and is configured to receive chord data and the user input information, and output a structured music score file and an audio file; and
the execution feedback module is integrated into the smart guitar, and is configured to parse the structured music score file to trigger a light indication and play the audio file in accordance with user's performance.

2. The AI-based creation system of claim 1, wherein the AI-based generation module comprises at least one AI creation model; and the at least one AI creation model is constructed by training a deep learning neural network using note information, lyric information and audio information.

3. The AI-based creation system of claim 1, wherein the input acquisition module comprises a chord touch button, a light-emitting diode (LED) light strip, a monophonic component, a toggling lever, an AI creation parameter input interface and an acquisition component;
the chord touch button is arranged at a neck portion of the smart guitar; a pressure sensor is provided below the chord touch button, and is configured to detect chord press;
the LED light strip is arranged at the neck portion of the smart guitar, and is configured to provide the light indication;
the monophonic component is arranged at a body of the smart guitar, and is configured to be triggered synchronously with the chord touch button;
the toggling lever is configured to detect upward or downward toggling actions and a push speed;
the AI creation parameter input interface is configured to receive an AI creation parameter input by a user; and
the acquisition component is configured to acquire the user input information via the application program of the mobile device.

4. The AI-based creation system of claim 3, wherein the user input information comprises audio, video, link, note, chord information, text, voice, image or a combination thereof.

5. The AI-based creation system of claim 3, wherein the monophonic component comprises a silicone base block and a plurality of string-plucking pieces;
wherein the plurality of string-plucking pieces are independent from each other, and are configured to protrude from a surface of the silicone base block;
each of the plurality of string-plucking pieces has a light-transmitting region and an LED light source corresponding to a bottom thereof; and
the pressure sensor is connected below each of the plurality of string-plucking pieces.

6. The AI-based creation system of claim 5, wherein the plurality of string-plucking pieces each have an elongated shape, and are uniformly arranged;
each of the plurality of string-plucking pieces has a length covering projection areas of six strings of the smart guitar;
the light-transmitting region is arranged at a top of each of the plurality of string-plucking pieces, and is configured as a circular opening or a semi-transparent silicone window; and
a center of the light-transmitting region is aligned with a projection of a corresponding string.

7. The AI-based creation system of claim 3, wherein the structured music score file comprises a chord sequence, a timestamp, a beats per minute (BPM) value and a timing error threshold;
the chord sequence is a chord identifier array corresponding to fret codes of the chord touch button arranged at the neck portion of the smart guitar;
the timestamp indicates an absolute time point for each chord transition;
the BPM value represents beats per minute; and
the timing error threshold represents an allowable playing error for user performance, and is calculated based on the BPM value.

8. The AI-based creation system of claim 1, wherein the execution feedback module comprises a music score parsing unit, a light driving unit, an audio synchronization unit and a comparison unit;
the music score parsing unit is configured to extract a timestamp and a chord sequence from the structured music score file;
the light driving unit is configured to control a light-up sequence of LEDs according to the timestamp;
the audio synchronization unit is configured to synchronize a playback progress with the light-up sequence of the LEDs; and
the comparison unit is configured to monitor a match degree between a chord played by a user and the chord sequence, and provide feedback to the user in case of a mismatch.

9. An AI-based creation method, the AI-based creation method being implemented by the AI-based creation system of claim 1, and the AI-based creation method comprising:
(S1) selecting and triggering, by a user via the display screen of the smart guitar or a bound mobile application, the AI-based creation function;
(S2) guiding, by the AI-based creation system, the user to input an AI creation parameter via a guitar input interface, the bound mobile application or a combination thereof;
(S3) collecting physical operation inputs from the user to the smart guitar, wherein the physical operation inputs comprise triggering a chord touch button, a monophonic button, a toggling action, a transposition operation or a tempo change operation;
(S4) transmitting, in real time, the AI creation parameter collected in step S2 and the physical operation inputs collected in step S3 to the cloud-based AI server;
(S5) generating, by the cloud-based AI server, the structured music score file and the audio file based on received data;
(S6) pushing, by the cloud-based AI server, the structured music score file and the audio file to the smart guitar, the bound mobile application or a combination thereof; and
(S7) receiving and parsing, by the smart guitar, the structured music score file to drive a LED light strip according to a timestamp to guide performance, and synchronously play the audio file.

10. The AI-based creation method of claim 9, before the step S1, further comprising:
(S11) displaying, on the display screen of the smart guitar, a quick response (QR) code or a link guide for downloading the bound mobile application;
(S12) after launching the bound mobile application, collecting a device ID of the smart guitar, and uploading the device ID together with a user account to the cloud-based AI server; and
(S13) verifying, by the cloud-based AI server, validity of the device ID, and upon successful verification, establishing and recording a binding relationship among the smart guitar, the bound mobile application and the user account.

11. The AI-based creation method of claim 9, wherein the step S4 comprises:
(S41) packaging real-time data from hardware of the smart guitar, wherein the real-time data comprises a transposition parameter obtained by monitoring a transposition touch button, a tempo parameter obtained by parsing the toggling action, and chord button pressure data obtained from a pressure sensor;
(S42) packaging creation parameters from the bound mobile application, wherein the creation parameters comprise input text of the user, recognized voice commands, analyzed image features, extracted audio melody and rhythm, parsed video content, information obtained from links, and directly inputted notes, chord data or a combination thereof; and
(S43) tagging all packaged data with a unified timestamp, and transmitting tagged data to the cloud-based AI server in real time and synchronously.

12. The AI-based creation method of claim 9, wherein in step S7, the step of driving the LED light strip according to the timestamp to guide performance, and synchronously playing the audio file comprises:
(S71) illuminating LEDs within a target chord area 500 ms before a target timestamp;
(S72) in the case of a performance error, repeating playback of a previous audio segment until a first chord timestamp is reached; and
(S73) matching a playback progress with timestamps in the structured music score file in real time.
